(19) United States
(12) Patent Application Publication
(10) Pub. No.: US 2004/0124599 A1
(43) Pub. Date: Jul. 1, 2004

(54) Shock-absorbing device for a rear wheel of an electric scooter

(76) Inventor: Dar-Hsiang Cheng, Tainan City (TW)

Correspondence Address: Dar-Hsiang Cheng, P.O. Box 90, Tainan City, 704, TW

(21) Appl. No.: 10/330,066

(22) Filed: Dec. 30, 2002

(51) Int. Cl. B62M 1/00

(52) U.S. Cl. 280/87.041

(57) ABSTRACT

A shock-absorbing device for a rear wheel of an electric scooter has two shock absorbers assembled between the rear wheel frame and the rear frame plate of an electric scooter. Each shock absorber has an adjusting ring threadably fitted on a tube which is assembled with the rear frame plate by a bolt inserted through the insert hole of the tube and a gasket and screwed with the fixing threaded rod, with a compression spring fitted around the tube. A protective ring and a washer are fitted around a lower rod, which is inserted in the tube, letting the opposite ends of the compression spring respectively pushing against the adjusting ring and the washer. A bolt inserted through the insert hole of the lower rod and the fixing hole of the rear wheel frame is screwed with a bolt-receiving member to combine the lower rod with the rear wheel frame.

### BACKGROUND OF THE INVENTION

1. Field of the Invention

This invention relates to a shock-absorbing device for a rear wheel of an electric scooter, particularly to one having two shock absorbers assembled between the rear wheel frame and the rear frame plate of an electric scooter, able to absorb vibration and bumping of the electric scooter by buffer action of the two shock absorbers and letting the electric scooter driven smoothly and comfortably.

2. Description of the Prior Art

A conventional electric scooter is not provided with the same shock absorbers as those of this invention; therefore, in case vibration and bumping occur, the conventional electric scooter cannot be driven smoothly and comfortably.

### SUMMARY OF THE INVENTION

This invention has been advised to offer a shock-absorbing device for a rear wheel of an electric scooter, able to absorb vibration and bumping of an electric scooter and enabling a user to drive the electric scooter smoothly and comfortably.

The feature of the invention is two shock absorbers assembled between the rear wheel frame and the rear frame plate of an electric scooter. Each shock absorber has an adjusting ring threadably combined with the male threads of a tube which is assembled with the rear frame plate by a bolt inserted through the insert hole of the tube as well as a gasket and screwed with the fixing threaded rod of the rear frame plate, a compression spring fitted around the tube, and a protective ring and a toggle orderly fitted around a lower vertical rod which is inserted in the inner hole of the tube, with the compression spring having its opposite ends respectively pushing against the adjusting ring and the toggle, the lower vertical rod fixedly assembled with the rear wheel frame by a bolt inserted through the insert hole of the lower vertical rod and the fixing hole of the rear wheel frame and then screwed fixedly with a bolt receiving member.

### BRIEF DESCRIPTION OF DRAWINGS

This invention will be better understood by referring to the accompanying drawings, wherein:

FIG. 1 is an exploded perspective view of a shock-absorbing device for a rear wheel of an electric scooter in the present invention;

FIG. 2 is a perspective view of the shock-absorbing device for a rear wheel of an electric scooter in the present invention; and,

FIG. 3 is a front view of the shock-absorbing device for a rear wheel of an electric scooter in a used condition in the present invention.

### DETAILED DESCRIPTION OF THE PREFERRED EMBODIMENT

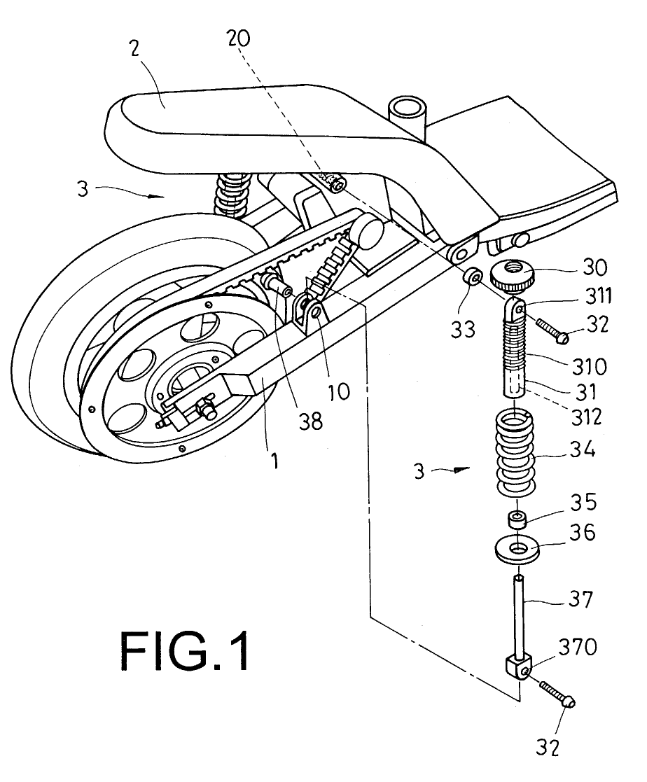

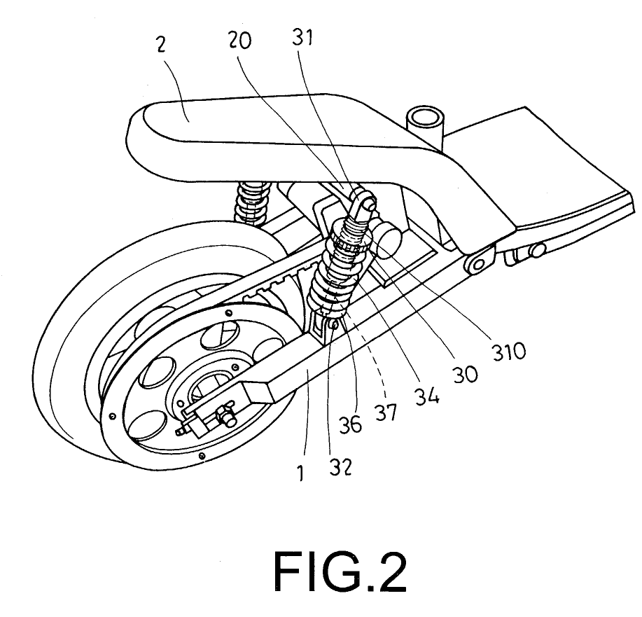

A preferred embodiment of a shock-absorbing device for a rear wheel of an electric scooter in the present invention, as shown in FIGS. 1 and 2, includes two shock absorbers 3 assembled between the rear wheel frame 1 and the rear frame plate 2 of an electric scooter. Each shock absorber 3 is composed of an adjusting ring 30, a tube 31, a compression spring 34, a protective ring 35, a washer 36 and a lower vertical rod 37 as main components combined together.

The adjusting ring 30 is threadably combined with the male threads 310 of the tube 31, which is assembled with rear frame plate 2 by a bolt 32 inserted through the insert hole 311 in the upper end of the tube 31 and a gasket 33 and screwed fixedly with the fixing threaded rod 20 of the rear frame plate 2.

The compression spring 34 is fitted around the tube 31, and the protective ring 35 and the washer 36 are orderly fitted around the lower vertical rod 37, which is inserted in the inner hole 312 of the tube 31, letting the opposite ends of the compression spring 34 respectively pushing against the adjusting ring 30 and the washer 36.

The lower vertical rod 37 is stably assembled with the rear wheel frame 1 by a bolt 32 inserted through the insert hole 370 at the lower end of the lower vertical rod 37 and the fixing hole 10 of the rear wheel frame and then screwed fixedly with a bolt receiving member 38 to finish assembly of the shock-absorbing device.

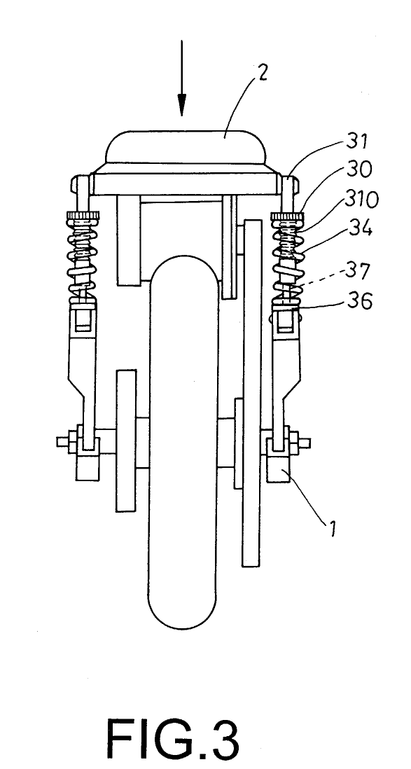

In using, as shown in FIGS. 1-3, the adjusting ring 30 is adjusted to a proper position on the male threads 310 of the tube 31 to let the compression spring 34 have its opposite ends respectively pushing against the adjusting ring 30 and the washer 36. Thus, when the electric scooter is pressed by gravitational force, the compression spring 34 will be compressed to contract and the lower vertical rod 37 will be moved to a comparatively deep position in the inner hole 312 of the tube 31. On the contrary, when no gravitational force is imposed on the electric scooter, the compression spring 34 and the vertical rod 37 will respectively recover its original position, able to absorb vibration and bumping of an electric scooter by buffer action of the two shock absorbers 3 and letting the electric scooter driven smoothly and comfortably.

While the preferred embodiment of the invention has been described above, it will be recognized and understood that various modifications may be made therein and the appended claims are intended to cover all such modifications that may fall within the spirit and scope of the invention.

What is claimed is:

1. A shock-absorbing device for a rear wheel of an electric scooter comprising:
two shock absorbers, said two shock absorbers assembled between the rear wheel frame and the rear frame plate of an electric scooter, each said shock absorber having an adjusting ring threadably engaged with the male threads of a tube, said tube assembled with said rear frame plate by a bolt which is inserted through the insert hole of said tube and a gasket and screwed fixedly with the fixing threaded rod of said rear frame plate, a compression spring fitted around said tube, a protective ring and a washer orderly fitted around a lower vertical rod, said lower vertical rod inserted in the inner hole of said tube, said compression spring having its opposite ends respectively pushing against said adjusting ring and said washer, said lower vertical rod assembled with said rear wheel frame by a bolt which is inserted through the insert hole of said lower vertical rod and the fixing hole of said rear wheel frame and screwed with a bolt receiving member; and,
said adjusting ring adjusted to a proper position on said male threads of said tube, said compression spring having its opposite ends respectively pushing against said adjusting ring and said washer, said compression spring compressed to contract and said lower vertical rod extending to a comparatively deep location in said inner hole of said tube when an electric scooter is pressed by gravity, said compression spring and said lower vertical rod respectively recovering its original position when no gravitational force is imposed on the electric scooter, said shock-absorbing device able to achieve an effect of absorbing vibrations and bumping of the electric scooter by buffer action of said two shock absorbers.
